(19) United States
(12) Patent Application Publication
(10) Pub. No.: US 2010/0066661 A1
(43) Pub. Date: Mar. 18, 2010

(54) LIQUID CRYSTAL PANEL, VIDEO DISPLAY DEVICE, AND VIDEO DISPLAY METHOD

(75) Inventor: Kunihiko Kawahara, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/393,909

(22) Filed: Feb. 26, 2009

(30) Foreign Application Priority Data
Sep. 12, 2008 (JP) 2008-235149

(51) Int. Cl. G09G 3/36

(52) U.S. Cl. 345/102; 345/87

(57) ABSTRACT

According to one embodiment, a lighting panel includes a display configured to switch a first video to a second video for display and a lighting module configured to, if while switching from the first video to the second video, the display displays a mixture of an area in which the first video is displayed and an area in which the second video is displayed, turn on lighting for at least a part of one of the area of the display in which the first video is displayed and the area of the display in which the second video is displayed.

### CROSS-REFERENCE TO RELATED APPLICATIONS

This application is based upon and claims the benefit of priority from Japanese Patent Application No. 2008-235149, filed Sep. 12, 2008, the entire contents of which are incorporated herein by reference.

### BACKGROUND

1. Field

One embodiment of the present invention relates to a control technique for allowing stereoscopic viewing of images on a liquid crystal panel with a backlight.

2. Description of the Related Art

Recent techniques allow users to enjoy stereoscopic viewing by watching images displayed on a monitor. Control is performed so as to allow the left eye to view only frame data intended to be viewed by the left eye, while allowing the right eye to view only frame data intended to be viewed by the right eye. Thus, the user can stereoscopically view the image.

An example of a method of allowing the user to stereoscopically view a screen displayed on the monitor is a method in which the user with a pair of glasses (stereoscopic LCD shutter glasses) each including a stereoscopic LCD shutter enabling the glass to be switched between an open state and a closed state views the screen on the monitor.

If the frame data intended to be viewed by the left eye and the frame data intended to be viewed by the right eye are alternately switched for display on a CRT (Cathode Ray Tube) monitor, the user can stereoscopically view these frame data because impulse characteristics of the CRT prevent these frame data from overlapping frame data preceding and succeeding these frame data on the monitor. However, on an LCD (Liquid Crystal Display) panel, linear sequentiality and hold characteristics cause frame data displayed on the monitor to be transiently switched. Thus, each frame data is fixed on the entire screen for only a short time. Thus, controlling the user's stereoscopic LCD shutter glasses is difficult, hindering stereoscopic viewing.

Jpn. Pat. Appln. KOKAI Publication No. 2005-77437 discloses a stereoscopic video display apparatus which displays a first observation image and a second observation image in a time division manner based on raster scan and which allows a dot matrix-like backlight to black out a partial area of the image according to the video.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an appearance of a digital broadcasting receiving, recording, and reproducing apparatus according to first embodiment;

FIG. 2 is a block diagram showing a signal processing system in the digital broadcasting receiving, recording, and reproducing apparatus according to the first embodiment;

FIG. 3 is a schematic diagram of a video display and a backlight according to the first embodiment;

FIG. 4 is a diagram showing control of the video display and the backlight and control of a stereoscopic LCD shutter glass (left) and a stereoscopic LCD shutter glass (right) according to the first embodiment;

FIG. 5 is a diagram showing control of the video display and the backlight and control of the stereoscopic LCD shutter glass (left) and the stereoscopic LCD shutter glass (right) according to the first embodiment;

FIG. 6 is a diagram showing control signals for the stereoscopic LCD shutter glass (right) and the stereoscopic LCD shutter glass (left) according to the first embodiment;

FIG. 7 is a diagram showing frame data displayed on the video display according to the first embodiment;

FIG. 8 is a diagram showing video display obtained when a backlight is controllably turned on and off according to the first embodiment;

FIG. 9 is a diagram showing videos viewed when the backlight is controllably turned on and off according to the first embodiment;

FIG. 10 is a flowchart of the on/off control of the backlight according to the first embodiment;

FIG. 11 is a diagram showing videos viewed when the backlight is controllably turned on and off according to a second embodiment;

FIG. 12 is a flowchart of the on/off control of the backlight according to the second embodiment;

FIG. 13 is a diagram showing videos viewed when the backlight is controllably turned on and off according to a third embodiment; and

FIG. 14 is a flowchart of the on/off control of the backlight according to the third embodiment.

### DETAILED DESCRIPTION

Various embodiments according to the invention will be described hereinafter with reference to the accompanying drawings. In general, according to one embodiment of the invention, lighting panel has a display configured to switch a first video to a second video for display and a lighting module configured to, if while switching from the first video to the second video, the display displays a mixture of an area in which the first video is displayed and an area in which the second video is displayed, turn on lighting for at least a part of one of the area of the display in which the first video is displayed and the area of the display in which the second video is displayed.

First, a video display apparatus including a liquid crystal panel to which a first embodiment is applied will be described in brief.

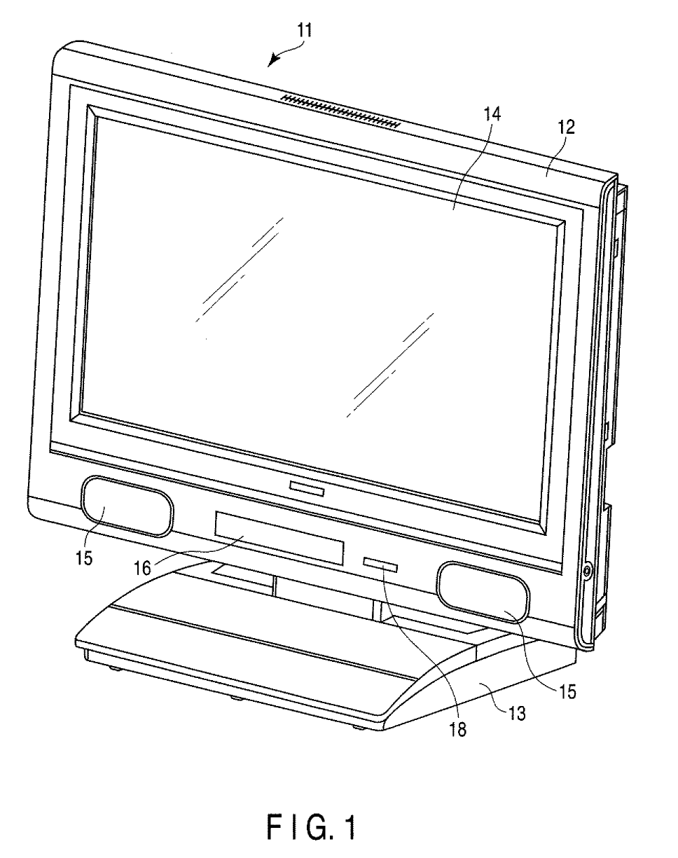

FIG. 1 shows an appearance of a digital television broadcasting receiving apparatus 11 described in the first embodiment. In the description of the first embodiment, the video display apparatus is the digital television broadcasting receiving apparatus 11. However, the first embodiment is not limited to this aspect but is applicable to a PC monitor or the like.

The digital television broadcasting receiving apparatus 11 is composed of a thin cabinet 12 and a support table 13 that supports the cabinet 12 upright. A video display 14, a speaker 15, an operation module 16, a light receiving module 18, and the like are installed in the cabinet 12; the video display 14 is of a flat panel type made up of, for example, a liquid crystal display panel, and the light receiving module 18 receives operation information transmitted by a remote controller 17.

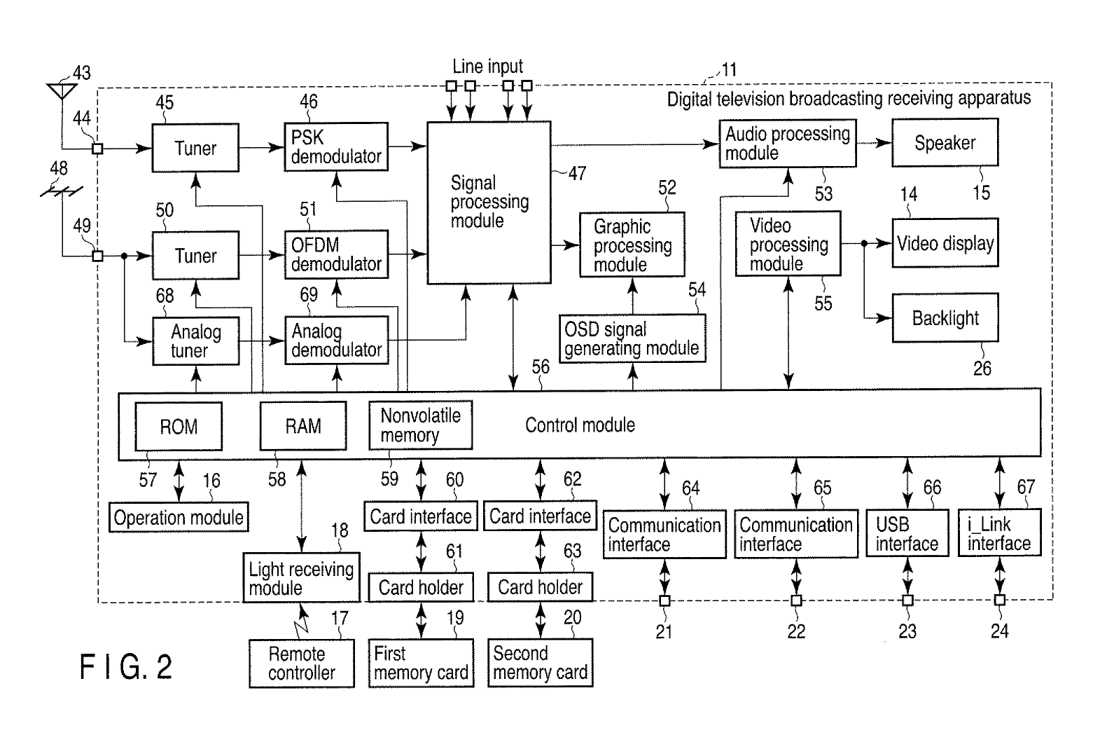

FIG. 2 shows a main signal processing system in the digital television broadcasting receiving apparatus 11. That is, a satellite digital television broadcasting signal received by a BS/CS digital broadcasting receiving antenna 43 is supplied to a satellite digital broadcasting tuner 45 via an input terminal 44 to select a broadcasting signal of a desired channel.

The broadcasting signal selected by the tuner 45 is supplied to a PSK (Phase Shift Keying) demodulator 46. The PSK demodulator 46 demodulates the broadcasting signal into a digital video signal and a digital audio signal, which are then output to a signal processing module 47.

An analog tuner 68 is also provided which receives terrestrial analog signals. A signal received by the tuner 68 is demodulated by an analog demodulator 69. The demodulated signal is then output to the signal processing module 47.

A terrestrial digital television broadcasting signal received by a terrestrial digital broadcasting receiving antenna 48 is supplied to a terrestrial digital broadcasting tuner 50 via an input terminal 49 to select a broadcasting signal of a desired channel.

The broadcasting signal selected by the tuner 50 is supplied to an OFDM (Orthogonal Frequency Division Multiplexing) demodulator 51. The OFDM demodulator 51 then demodulates the signal into a digital video signal and a digital audio signal, which are then output to the signal processing module 47.

Here, the signal processing module 47 selectively carries out predetermined digital signal processing on the digital video and audio signals supplied by the PSK demodulator 46, the digital video and audio signals supplied by the OFDM demodulator 51, a video signal and an audio signal supplied by the analog demodulator 69, and a video signal and an audio signal from the line input terminal. The signal processing module 47 then outputs the processed signals to a graphic processing module 52 and an audio processing module 53.

The graphic processing module 52 includes a function of superimposing an OSD signal generated by an On Screen Display (OSD) signal generating module 54 on the digital video signal supplied by the signal processing module 47 and then outputting the resulting signal. The graphic processing module 52 can selectively output the output signal from the signal processing module 47 and the output OSD signal from the OSD signal generating module 54, and combinatorily output both output signals so that each of the signals makes up half of a screen.

The digital video signal output by the graphic processing module 52 is supplied to the video processing module 55. The video processing module 55 converts the input digital video signal into an analog video signal of a format that can be displayed on the video display 14. The video processing module 55 then outputs the analog video signal to the video display 14 to display the corresponding video.

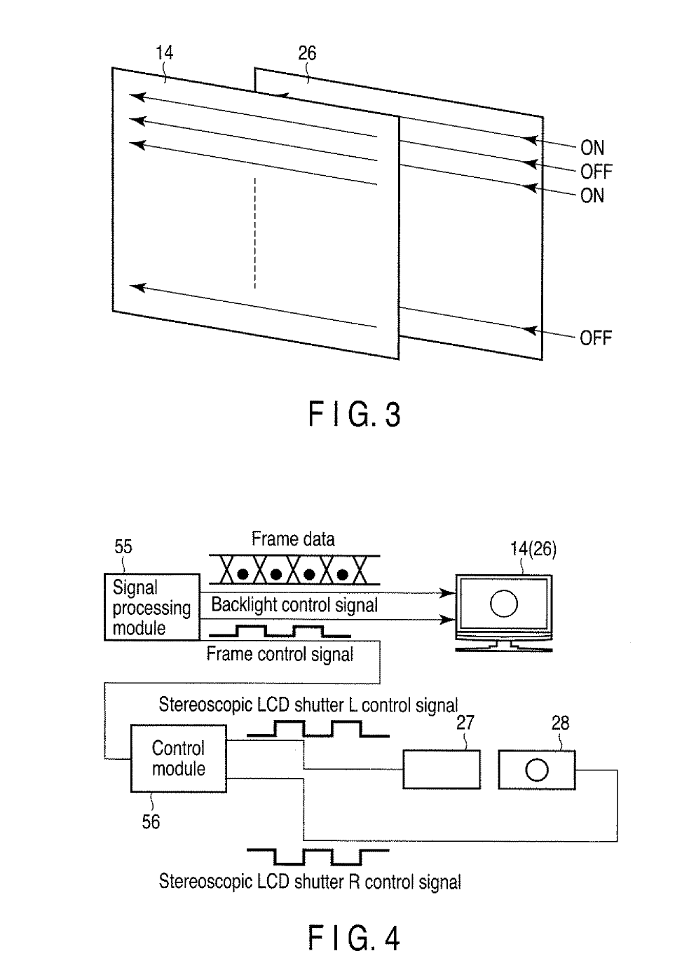

The video processing module 55 further performs on/off control on the backlight 26. FIG. 3 shows a schematic diagram of display of a video signal by the video display 14 and the on/off control of the backlight 36. The video display 14 includes a plurality of scan lines arranged from top to bottom of the screen and extending in a horizontal direction. The video processing module 55 sequentially rewrites the video signal line by line from the top scan line to bottom scan line of the video display 14 in the direction of an arrow in the figure to display one frame data.

The backlight 26 lights the video display 14 from a back surface. The backlight 26 can light the video display 14 for each of the scan lines on the video display 14. The video processing module 55 performs the on/off control to determine which of the scan lines on the video display 14 is to be lighted by the backlight 26. A user can view the frame data in a part of the video display 14 lighted by the backlight 26. In contrast, the user cannot view the frame data in a part of the video display 14 not lighted by the backlight 26. The on/off control of the backlight 26 according to the first embodiment will be described below in detail.

The audio processing module 53 converts the input digital audio signal into an analog audio signal of a format that can be reproduced by a speaker 15. The audio processing module 53 then outputs the analog audio signal to the speaker 15 to reproduce the corresponding sound.

Here, all operations of the digital television broadcasting receiving apparatus 11, including the above-described receiving operations, are integrally controlled by a control module 56.

The control module 56 contains a Central Processing Unit (CPU) and the like. Upon receiving operation information from the operation module 16 or receiving operation information transmitted by the remote controller 17, via the light receiving module 18, the control module 56 controls relevant modules so that the contents of the operation are reflected in the apparatus.

In this case, the control module 56 utilizes a Read-Only Memory (ROM) 57 in which control programs to be executed by CPU are stored, Random Access Memory (RAM) 58 that provides a work area for CPU, and a nonvolatile memory 59 in which various pieces of setting information and control information are stored.

The control module 56 is connected, via a card interface 60 to a card holder 61 in which a first memory card 19, for example, a Secure Digital (SD) memory card, Multimedia Card (MMC), or a memory stick can be installed. Thus, the control module 56 can transmit and receive information to and from the card interface 60 installed in the card holder 61, via the first memory card 19.

The control module 56 is connected via a card interface 62 to a card holder 63 in which a second memory card 20 can be installed. Thus, the control module 56 can transmit and receive information to and from the second memory card 20 installed in the card holder 63, via the card interface 62.

The control module 56 is connected to a first Local Area Network (LAN) terminal 21 via a communication interface 64. Thus, the control module 56 can transmit information to and from various pieces of equipment via the communication interface 64.

A stereoscopic LCD shutter glass (left) 27 and a stereoscopic LCD shutter glass (right) 28 such as those shown in FIGS. 4 and 5 are connected to the first LAN terminal 21. The user wears the stereoscopic LCD shutter glass (left) 27 and the stereoscopic LCD shutter glass (right) 28, over the left and right eyes, respectively. The control module 56 controllably brings the stereoscopic LCD shutter glass (left) 27 and the stereoscopic LCD shutter glass (right) 28 into an open state or a closed state. Thus, the user can enjoy stereoscopic viewing by allowing the left and right eyes to watch videos intended to be viewed by the left eye and videos intended to be viewed by the right eye, respectively. Description will be given below of controllable switching, by the control module 56, of the stereoscopic LCD shutter glass (left) 27 and the stereoscopic LCD shutter glass (right) 28 between the open state and the closed state.

The control module 56 is connected to the second LAN terminal 22 via the communication interface 65. Thus, the control module 56 can transmit and receive information to and from LAN-compatible HDD connected to a second LAN terminal 23, via the communication interface 65. In this case, the control module 56 includes a Dynamic Host Configuration Protocol (DHCP) server function to controllably assign an Internet Protocol (IP) address to a LAN-compatible HDD connected to the second LAN terminal 22.

The control module 56 is used to record and reproduce information, via Ethernet (registered trade mark) in and from a LAN-compatible HDD that is Network Attached Storage (NAS) connected to the second LAN terminal 22.

Thus, providing the second LAN terminal 22 serving as a port dedicated to a LAN-compatible HDD enables program information to be recorded in HDD with high vision quality without being affected by other network environments or the usage of the network.

The control module 56 is connected to the USB terminal 23 via a Universal Serial Bus (USB) interface 66. Thus, the control module 56 can transmit and receive information to and from equipment connected to the USB terminal 23, via USB interface 66.

The control module 56 is connected to an i. Link (registered trade mark) terminal 24 via an i. Link (registered trade mark) interface 67. Thus, the control module 56 can transmit and receive information to and from equipment connected to the i. Link (registered trade mark) 24, via i. Link (registered trade mark) interface 67.

FIGS. 4 and 5 are diagrams showing control the video display 14 and the backlight 26 and control of the stereoscopic LCD shutter glass (left) 27 and the stereoscopic LCD shutter glass (right) 28. FIG. 4 is a block diagram showing how a control system operates to bring the stereoscopic LCD shutter glass (right) into the open state. FIG. 5 is a block diagram showing how a control system operates to bring the stereoscopic LCD shutter glass (left) into the open state. The control module 56 controllably brings the stereoscopic LCD shutter glass (left) 27 into the open or closed state. When the stereoscopic LCD shutter glass (left) 27 is in the open state, the user can view the video displayed on the video display 14 with the left eye. When the stereoscopic LCD shutter glass (left) 27 is in the closed state, the field of view of the user's left eye is blocked, and the user cannot view the video displayed on the video display 14 with the left eye. Similarly, the stereoscopic LCD shutter glass (right) 28 is a lens for the right eye. The control module 56 controllably brings the stereoscopic LCD shutter glass (right) 28 into the open or closed state. When the stereoscopic LCD shutter glass (right) 28 is in the open state, the user can view the video displayed on the video display 14 with the right eye. When the stereoscopic LCD shutter glass (right) 28 is in the closed state, the field of view of the user's left eye is blocked, and the user cannot view the video displayed on the video display 14 with the right eye.

As shown in FIGS. 4 and 5, the video processing module 55 transmits frame data that is a video signal to the video display 14. The video processing module 55 sequentially transmits a video intended to be viewed by the right eye and a video intended to be viewed by the left eye, as frame data. The video processing module 55 also transmits a backlight control signal composed of an H signal and an L signal which controllably turns on and off the backlight 26, which lights the video display 14. The video processing module 55 transmits a frame control signal to the control module 56. The frame control signal indicates the status of the frame data. If the frame data intended to be viewed by the left eye is output to the video display 14, the frame control signal changes to the L signal to bring the stereoscopic LCD shutter glass (left) 27 into the open state. If the frame data intended to be viewed by the right eye is output to the video display 14, the frame control signal changes to the H signal to bring the stereoscopic LCD shutter glass (right) 28 into the open state.

The control module 56 transmits a shutter L side control signal that controllably brings the stereoscopic LCD shutter glass (left) 27 into the open or closed state. Similarly, the control module 56 transmits a shutter R side control signal that controllably brings the stereoscopic LCD shutter glass (right) 28 into the open or closed state. Depending on whether the frame control signal is at the L or H level, the control module 56 transmits a signal to the stereoscopic LCD shutter glass (left) 27 to controllably bring the stereoscopic LCD shutter glass (left) 27 into the open or closed state, while transmitting a signal to the stereoscopic LCD shutter glass (right) 28 to controllably bring the stereoscopic LCD shutter glass (right) 28 into the closed or open state.

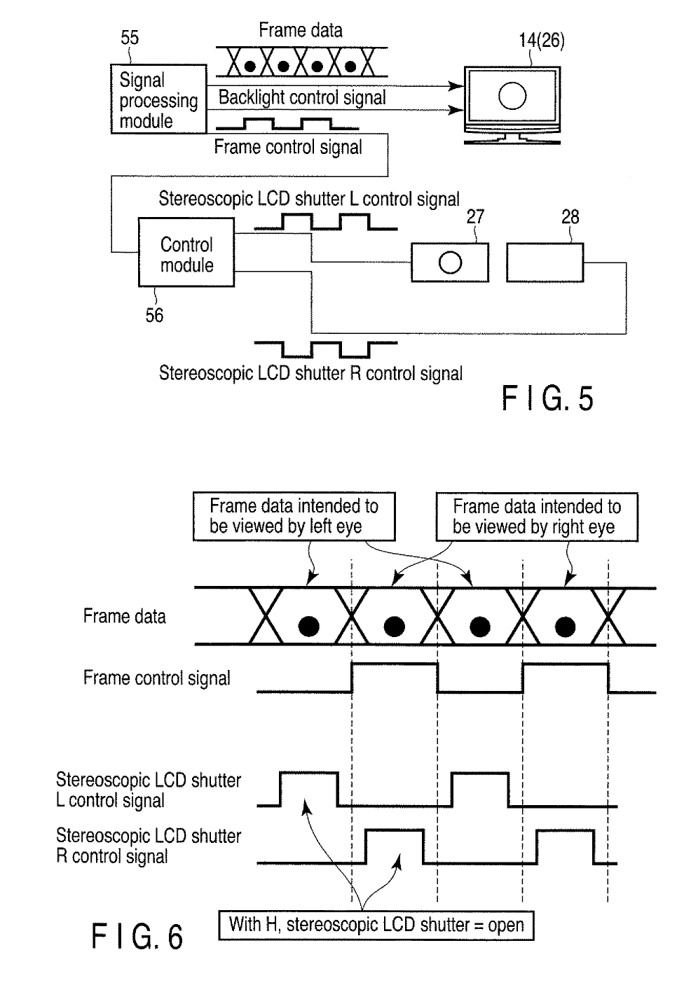

FIG. 6 is a diagram showing how the control signals operate to bring the stereoscopic LCD shutter glass (right) 27 and the stereoscopic LCD shutter glass (left) 28 into the open or closed state. FIG. 6 shows, along a time sequence, frame data input to the video display 14 by the video processing module 55, a frame control signal input to the control module 56 by the video processing module 55, the shutter L side control signal, controllably allowing the video processing module 55 to bring the stereoscopic LCD shutter glass (left) 27 into the open or closed state, and the shutter R side control signal, controllably allowing the video processing module 55 to bring the stereoscopic LCD shutter glass (right) 28 into the open or closed state.

The video display 14 alternately displays the frame data intended to be viewed by the user's left eye and the frame data intended to be viewed by the user's right eye. If the video processing module 55 transmits the frame data intended to be viewed by the user's left eye, to the video display 14, the video processing module 55 then transmits the frame control signal set to the L level to the control module 56 in order to bring the stereoscopic LCD shutter glass (left) 27 into the open state.

The control module 56 transmits the shutter L side control signal set to the H level to the stereoscopic LCD shutter glass (left) 27 in order to bring the stereoscopic LCD shutter glass (left) 27 into the open state. The stereoscopic LCD shutter glass (left) 27 is thus placed in the open state. At this time, the control module 56 transmits the shutter R side control signal set to the L level to the stereoscopic LCD shutter glass (right) 28 in order to bring the stereoscopic LCD shutter glass (right) 28 into the closed state. The stereoscopic LCD shutter glass (right) 28 is thus placed in the closed state. This is shown in FIG. 5. The user can view the frame data displayed on the video display 14 only with the left eye.

Then, If the video processing module 55 transmits the frame data intended to be viewed by the user's right eye, to the video display 14, the video processing module 55 then transmits the frame control signal set to the H level to the control module 56 in order to bring the stereoscopic LCD shutter glass (right) 28 into the open state.

The control module 56 transmits the shutter R side control signal set to the H level to the stereoscopic LCD shutter glass (right) 28 in order to bring the stereoscopic LCD shutter glass (right) 28 into the open state. The stereoscopic LCD shutter glass (right) 28 is thus placed in the open state. At this time, the control module 56 transmits the shutter L side control signal set to the L level to the stereoscopic LCD shutter glass (left) 27 in order to bring the stereoscopic LCD shutter glass (left) 27 into the closed state. The stereoscopic LCD shutter glass (left) 27 is thus placed in the closed state. This is shown in FIG. 4. The user can view the frame data displayed on the video display 14 only with the right eye.

As described above, the control module 56 controls the open and close states of each of the stereoscopic LCD shutter glass (left) 27 and the stereoscopic LCD shutter glass (right) 28.

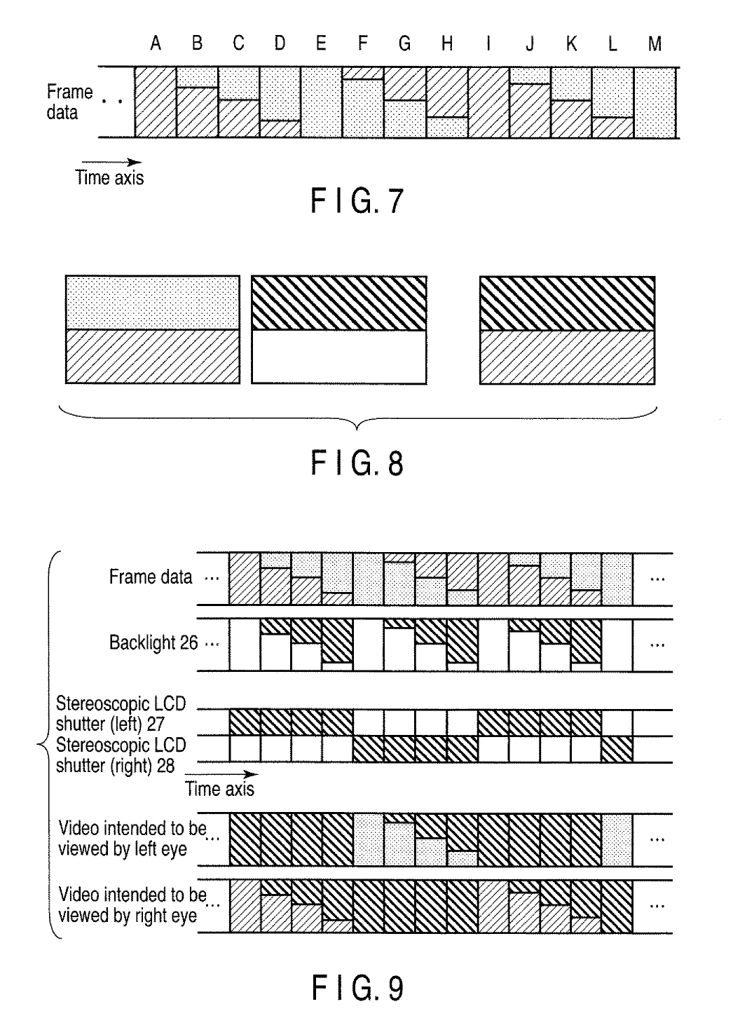

Now, the frame data output to the video display 14 that is a liquid crystal panel will be described with reference to FIG. 7.

The video display 14 displays frames A, B, C, D, E, F, G, H, I, J, K, L, and M on the screen in this order along a time axis. In an example described below, first frame data is output to a frame A and then second, third, and fourth frame data are output the frame A. Portions of the frames which are shaded with thin diagonal lines indicate the first and third frame data. The portions shaded with the thin diagonal lines also indicate the frame data intended to be viewed by the right eye. Dot portions of the frames indicate second and fourth frame data. The dot portions also indicate the frame data intended to be viewed by the left eye.

Here, the video processing module 55 sequentially outputs the first frame data (the state of the frame A), the second frame data (the state of the frame E), the third frame data (the state of the frame I), and the fourth frame data (the state of the frame M) in this order.

Since the video display 14 is a liquid crystal display, the linear sequentiality and hold characteristic of the liquid crystal display make it difficult to instantaneously switch the frame A to the frame E for display.

The video processing module 55 writes new frame data to each line on the screen of the video display 14 from top to bottom of the screen. Thus, to switch the display on the screen from the state of the frame A to the state of the frame E, the video display 14 displays the first frame data and the second frame data on one screen so that the first frame data and the second frame data overlap, for example, as shown in the frames B, C, and D. The second frame data replaces the first frame data displayed on the screen, line by line from top to bottom of the screen.

The frame B shows the state in which the video display 14 displays the second frame data in an upper quarter of the screen, while still displaying the first frame data in lower three-fourths of the screen. The frame C corresponds to a state a certain time after the state of the frame B; the video display 14 displays the second frame data in an upper half of the screen, while still displaying the first frame data in a lower half of the screen. The frame D corresponds to a state a certain time after the state of the frame C; the video display 14 displays the second frame data in upper three-fourths of the screen, while still displaying the first frame data in a lower quarter of the screen. The frame E corresponds to a state a certain time after the state of the frame D; the video display 14 displays the entire second frame data.

Likewise, to switch the display on the screen from the state of the frame E to the state of the frame I, the video display 14 displays the second frame data and third frame data on one screen so that the second frame data and the third frame data overlap, for example, as shown in the frames F, G, and H.

The frame F shows the state in which the video display 14 displays the third frame data in the upper quarter of the screen, while still displaying the second frame data in the lower three-fourths of the screen. The frame G corresponds to a state a certain time after the state of the frame F; the video display 14 displays the third frame data in the upper half of the screen, while still displaying the second frame data in the lower half of the screen. The frame H corresponds to a state a certain time after the state of the frame G; the video display 14 displays the third frame data in the upper three-fourths of the screen, while still displaying the second frame data in the lower quarter of the screen. The frame I corresponds to a state a certain time after the state of the frame H; the video display 14 displays the entire third frame data.

Moreover, to switch the display on the screen from the state in which the frame I is output to the state in which the frame M is output, the video display 14 displays the third frame data and fourth frame data on one screen so that the third frame data and the fourth frame data overlap, for example, as shown in the frames J, K, and L.

The frame J shows the state in which the video display 14 displays the fourth frame data in the upper quarter of the screen, while still displaying the third frame data in the lower three-fourths of the screen. The frame K corresponds to a state a certain time after the state of the frame J; the video display 14 displays the fourth frame data in the upper half of the screen, while still displaying the third frame data in the lower half of the screen. The frame L corresponds to a state a certain time after the state of the frame K; the video display 14 displays the fourth frame data in the upper three-fourths of the screen, while still displaying the third frame data in the lower quarter of the screen. The frame N corresponds to a state a certain time after the state of the frame H; the video display 14 displays the entire fourth frame data.

FIG. 8 is video outputs obtained when the backlight 26 is controllably turned on and off for the video display 14 showing a screen, as described above. A left part of FIG. 8 shows frame data displayed by the video display 14. The frame data indicates the state of the frame C in FIG. 7. The frame C corresponds to the state in which the video display 14 displays the second frame data in the upper half of the screen, while still displaying the first frame data in the lower half of the screen.

A middle part of the FIG. 8 shows how the backlight 26, which lights the video display 14, is turned on and off. The video processing module 55 controls the backlight 26 so that a part of the backlight which corresponds to the upper half of the video display 14 is turned off (the upper half is shown with thick diagonal lines in the figure), while a part of the backlight which corresponds to the lower half of the video display 14 is turned on (the lower part is shown in white in the figure).

A right part of FIG. 8 shows frame data actually viewed by the user. When the frame data displayed on the video display 14 (the left part of FIG. 8) is allowed to overlap a position on the screen which is lighted by the video display 14, the user's eyes do not view the second frame data displayed in the upper half of the video display 14 with the backlight 26 turned off. The user's eyes view only the lower half of the frame data displayed in the lower half of the video display 14 with the backlight 26 turned on.

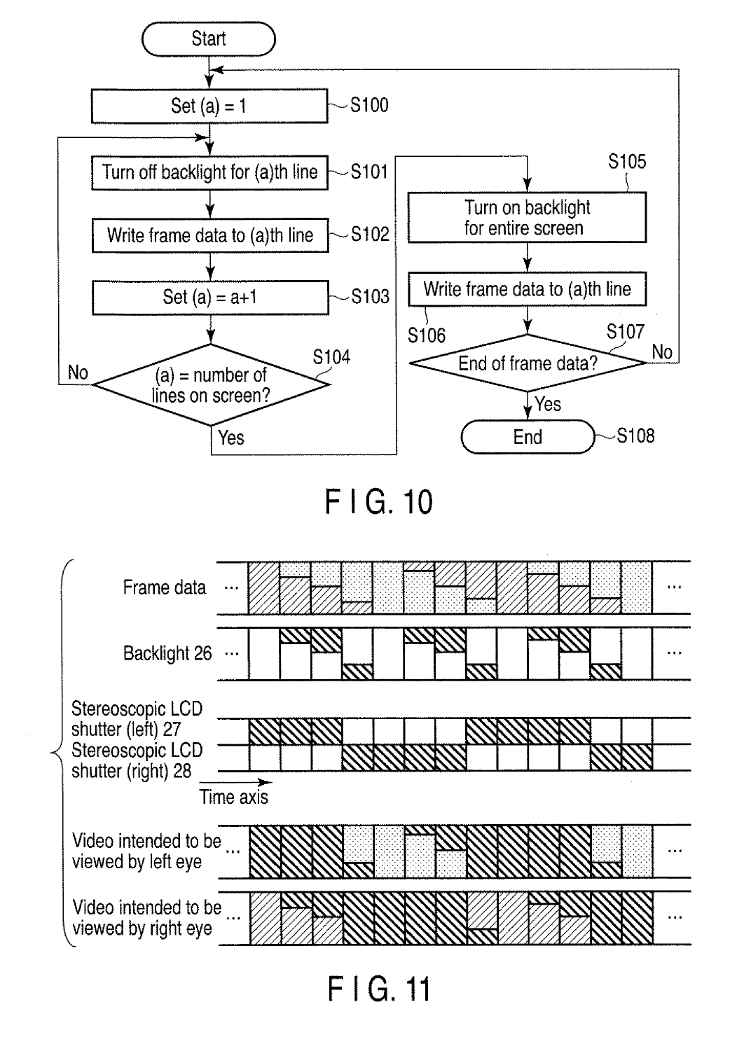

Now, a first embodiment of the on/off control of the backlight 26 in the digital television broadcasting receiving apparatus 11 will be described with reference to FIGS. 9 and 10.

FIG. 9 is a diagram showing the on/off control of the backlight 26 according to the first embodiment, and videos viewed by the user in association with the on/off control.

FIG. 9 shows, from top to bottom of the figure, the frames A to M, shown in FIG. 7, turning-on and -off of the backlight 26, the open state/closed state of the stereoscopic LCD shutter glass (left) 27 and the stereoscopic LCD shutter glass (right) 28, and videos viewed by the left and right eyes under the above-described three conditions.

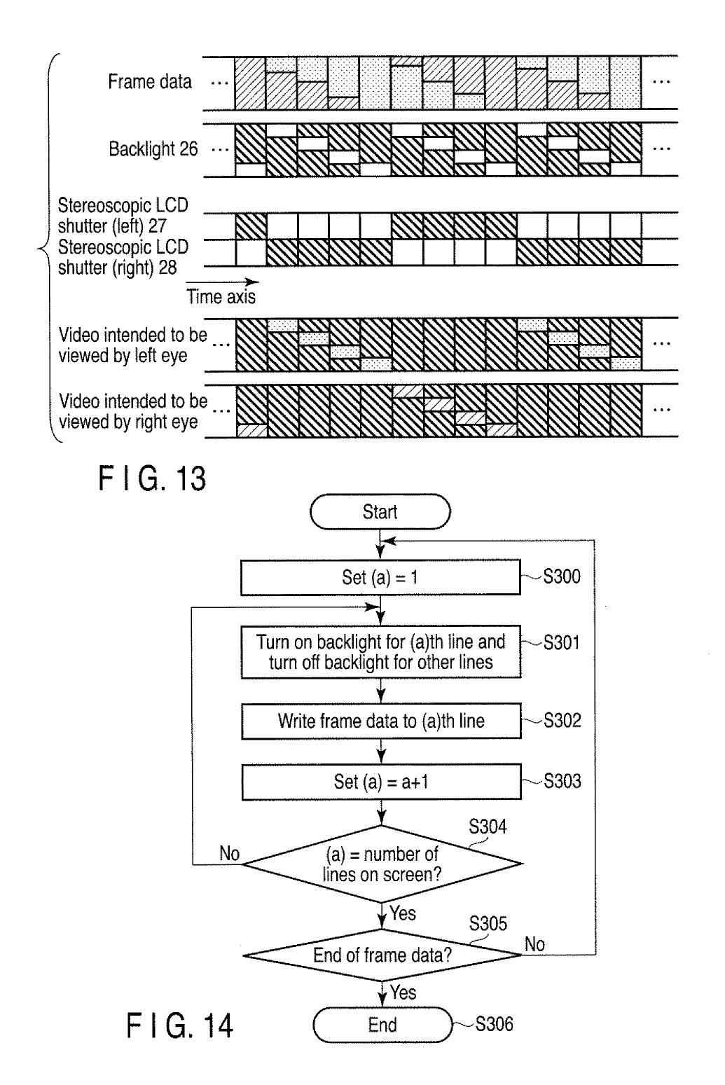

A part with thick diagonal lines in the figure of turning-on and -off of the backlight 26 means the backlight 26 is turned off. A part in white in the figure of turning-on and -off of the backlight 26 means the backlight 26 is turned on. A part with thick diagonal lines in the figure of the open state/closed state of the stereoscopic LCD shutter glass (left) 27 and the stereoscopic LCD shutter glass (right) 28 means the closed state. A part in white in the figure of the open state/closed state of the stereoscopic LCD shutter glass (left) 27 and the stereoscopic LCD shutter glass (right) 28 means the open state. These also apply to the case in FIG. 11 and FIG. 13.

Now, the on/off control of the backlight will be described with reference to FIG. 10. First, the video processing module 55 sets (a)=1 to control the video display 14 and the backlight 26 (step S100). The video processing module 55 turns off a part of the backlight 26 which corresponds to the (a)th line (first, the first line) from the top of the screen (step S101).

Then, the video processing module 55 writes frame data to the (a)th line on the screen of the video display 14 (step S102). Then, the video processing module 55 sets (a)=a+1 to control the video display 14 and the backlight 26 (step S103). The video processing module 55 determines whether or not (a)=the number of lines on the screen of the video display 14 (step S104). If (a) is not the number of lines on the screen of the video display 14 (step S104, NO), the video processing module 55 returns to step S101. If (a) is the number of lines on the screen of the video display 14 (step S104, YES), the video processing module 55 turns on the entire backlight 26, corresponding to the entire screen of the video display (step S105). The video processing module 55 writes frame data to the (a)th line (final line) on the screen of the video display 14 (step S106).

The video processing module 55 determines whether or not any frame data is present which is to be displayed on the screen of the video display 14 (step S107). If the current frame data is the final (step S107, YES), the video processing module 55 terminates the control of the video display 14 and the backlight 26 (step S108). If the current frame data is not the final (step S107, NO), the video processing module 55 returns to step S100 to control the video display 14 and the backlight 26.

That is, every time new frame data is written to a new line on the screen of the video display 14 which is located immediately below the last line to which the frame data has been written as shown in FIG. 10, the video processing module 55 controllably turns off a part of the backlight 26 from the top of the screen down to the line to which the frame data has newly been written, unless the frame data is written to all the lines on the screen.

Furthermore, during display of the frames A to D, the control module 56 performs control such that the stereoscopic LCD shutter glass (left) 27 is in the closed state (this corresponds to the thick diagonal lines in the figure), whereas the stereoscopic LCD shutter glass (right) 28 is in the open state (this corresponds to the white part in the figure). Then, during display of the frames E to H, the control module 56 performs control such that the stereoscopic LCD shutter glass (left) 27 is in the open state, whereas the stereoscopic LCD shutter glass (right) 28 is in the closed state. Then, during display of the frames I to L, the control module 56 performs control such that the stereoscopic LCD shutter glass (left) 27 is in the closed state, whereas the stereoscopic LCD shutter glass (right) 28 is in the open state.

After the video display 14 starts to completely display the frame data intended to be viewed by the right eye and before the video display 14 starts to completely display the frame data intended to be viewed by the left eye, the stereoscopic LCD shutter glass (left) 27 is in the closed state, whereas the stereoscopic LCD shutter glass (right) 28 is in the open state. That is, if the video display 14 overlappingly displays the frame data intended to be viewed by the left eye, in the upper part of the screen, and the frame data intended to be viewed by the right eye, in the lower part of the screen, the stereoscopic LCD shutter glass (left) 27 is brought into the closed state, whereas the stereoscopic LCD shutter glass (right) 28 is brought into the open state.

In contrast, after the video display 14 starts to completely display the frame data intended to be viewed by the left eye and before the video display 14 starts to completely display the frame data intended to be viewed by the right eye, the stereoscopic LCD shutter glass (left) 27 is in the opened state, whereas the stereoscopic LCD shutter glass (right) 28 is in the closed state. That is, if the video display 14 overlappingly displays the frame data intended to be viewed by the right eye, in the upper part of the screen, and the frame data intended to be viewed by the left eye, in the lower part of the screen, the stereoscopic LCD shutter glass (left) 27 is brought into the open state, whereas the stereoscopic LCD shutter glass (right) 28 is brought into the closed state.

The frame data videos displayed on the video display 14 and viewed by the user's right and left eyes are as shown in FIG. 9 by the above-described on/off control on the backlight 26 and the corresponding control for bringing the stereoscopic LCD shutter glass (left) 27 and the stereoscopic LCD shutter glass (right) 28 into the open or closed state.

That is, as shown in FIG. 8, if the backlight 26 is off, the frame data displayed on the video display 14 is not viewed by the user. Furthermore, as shown in FIGS. 4 and 5, when the stereoscopic LCD shutter glass (left) 27 is in the closed state, the frame data displayed on the video display 14 is not viewed by the user's left eye. Similarly, when the stereoscopic LCD shutter glass (right) 28 is in the closed state, the frame data displayed on the video display 14 is not viewed by the user's right eye.

Thus, during the display of the frames A to D when the stereoscopic LCD shutter glass (left) 27 is in the closed state, the frame data displayed on the video display 14 is not viewed by the user's left eye via the stereoscopic LCD shutter glass (left) 27. Then, while the frames E to H are being displayed on the video display 14, since the stereoscopic LCD shutter glass (left) 27 is in the open state, the frame data displayed on the video display 14 is viewed by the user's left eye via the stereoscopic LCD shutter glass (left) 27. In this case, as a result of turning off the relevant part of the backlight 26 every time the frame data intended to be viewed by the right eye is written to a new line on the screen of the video display 14 which is located immediately below the last line to which the frame data has been written, a part of the backlight 26 from the top of the screen down to the new line to which the frame data has been written has been turned off. Thus, only a part of the frame data displayed on the video display 14 which is intended to be viewed by the user's left eye is viewed by the user's left eye via the stereoscopic LCD shutter glass (left) 27.

In contrast, while the frames A to D are being displayed on the video display 14, since the stereoscopic LCD shutter glass (right) 28 is in the open state, the frame data displayed on the video display 14 is viewed by the user's right eye via the stereoscopic LCD shutter glass (right) 28. In this case, as a result of turning off the relevant part of the backlight 26 left time the frame data intended to be viewed by the right eye is written to a new line located immediately below the last line to which the frame data has been written, a part of the backlight 26 from the top of the screen down to the new line to which the frame data has been written has been turned off. Thus, only a part of the frame data displayed on the video display 14 which is intended to be viewed by the user's right eye is viewed by the user's right eye via the stereoscopic LCD shutter glass (right) 28. Then, while the frames E to H are being displayed on the video display 14, since the stereoscopic LCD shutter glass (right) 28 is in the closed state, the frame data displayed on the video display 14 is not viewed by the user's right eye via the stereoscopic LCD shutter glass (right) 28. Then, while the frames I to L are being viewed on the video display 14, only the part of the frame data displayed on the video display 14 which is intended to be viewed by the user's right eye is viewed by the user's right eye via the stereoscopic LCD shutter glass (right) 28 as is the case with the frames I to L, described above.

According to the above-described embodiment, even if the frame data intended to be viewed by the user's right eye overlaps the frame data intended to be viewed by the user's left eye in one frame, only the frame data intended to be viewed by each eye is viewed by that eye. Consequently, regardless of the operation speed of the frame data displayed on the video display 14, afterimages in the stereoscopic viewing can be reduced. Furthermore, the present embodiment allows the backlight 26, the stereoscopic LCD shutter glass (left) 27, and the stereoscopic LCD shutter glass (right) 28 to be easily controlled.

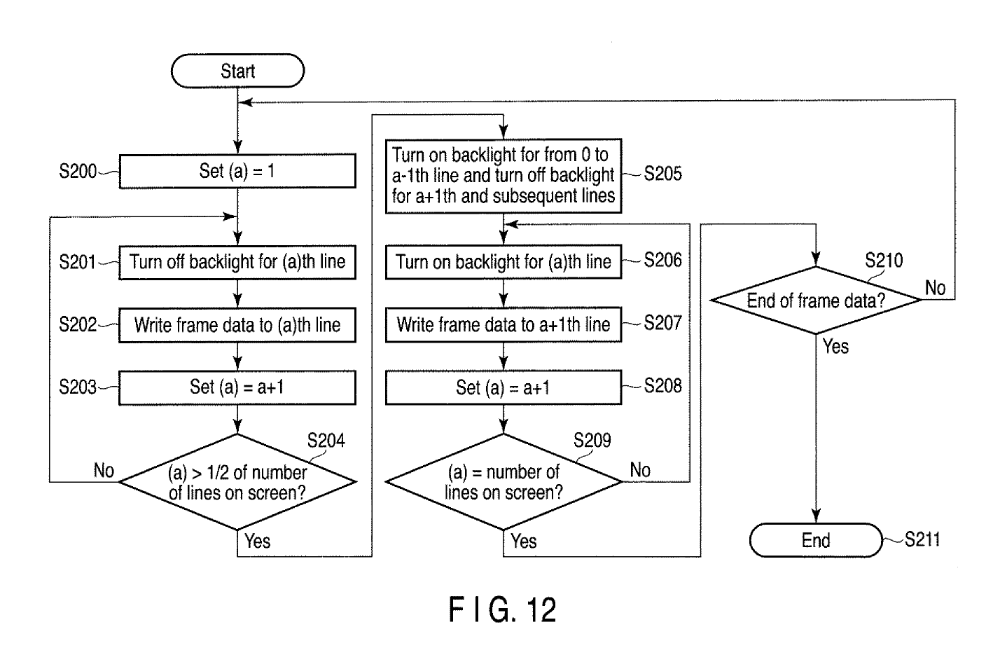

Now, the on/off control of the backlight 26 in the digital television broadcasting receiving apparatus 11 according to a second embodiment will be described with reference to FIGS. 11 and 12.

Like FIG. 9, FIG. 11 shows the on/off control of the backlight 26 according to the second embodiment and images viewed by the user. Now, the on/off control of the backlight 26 will be described with reference to a flowchart shown in FIG. 12.

First, the video processing module 55 sets (a)=1 to control the video display 14 and the backlight 26 (step S200). The video processing module 55 turns off a part of the backlight 26 which corresponds to the (a)th line (first, the first line) from the top of the screen (step S201).

Then, the video processing module 55 writes frame data to the (a)th line on the screen of the video display 14 (step S202). Then, the video processing module 55 sets (a)=a+1 to control the video display 14 and the backlight 26 (step S203). The video processing module 55 determines whether or not the number of the lines from the uppermost line down to the (a)th line is greater than half of the total number of lines on the screen of the video display 14 (step S204). If the number of the lines from the uppermost line down to the (a)th line is not greater than half of the total number of lines on the screen of the video display 14 (step S204, NO), the video processing module 55 returns to step S101. If the number of the lines from the uppermost line down to the (a)th line is greater than half of the total number of lines on the screen of the video display 14 (step S204, YES), the view processing module 55 turns on a part of the backlight 26 which corresponds to the 0 to a−1th line, while turning off a part of the backlight which corresponds to a+1th and subsequent lines (step S205). The video processing module 55 then turns on a part of the backlight 26 which corresponds to the (a)th line on the video display 14 (step S206). The video processing module 55 then writes frame data to the a+1th line on the screen of the video display 14 (step S207). The video processing module 55 sets (a)=a+1 to control the video display 14 and the backlight 26 (step S208).

The video processing module 55 determines whether or not (a) is equal to the number of the final line on the screen of the video display 14 (step S209). If (a) is not equal to the number of the final line on the screen of the video display 14 (step S209, NO), the video processing module 55 returns to step S206. If (a) is equal to the number of the final line on the screen of the video display 14 (step S209, YES), the video processing module 55 determines whether or not any frame data is present which is to be displayed on the screen of the video display 14 (step S210). If the current frame data is the final (step S210, YES), the video processing module 55 terminates the control of the video display 14 and the backlight 26 (step S211). If the current frame data is not the final (step S210, NO), the video processing module 55 returns to step S200 to control the video display 14 and the backlight 26.

That is, as shown in FIG. 11, the video processing module 55 performs control such that new frame data is written to the screen of the video display 14 line by line from top to bottom of the screen so as to turn on a part of the backlight 26 which corresponds to frame data corresponding to at least half of all the lines in the frame of the video display 14.

The control module 56 performs control such that if frame data corresponding to at least half of all the lines in the frame of the video display 14 is intended to be viewed by the left eye, the stereoscopic LCD shutter glass (left) 27 is brought into the open state (this corresponds to the thick diagonal lines in the figure), whereas the stereoscopic LCD shutter glass (right) 28 is brought into the closed state (this corresponds to the white part in the figure). In contrast, the control module 56 performs control such that if the frame data corresponding to at least half of all the lines in the frame of the video display 14 is intended to be viewed by the right eye, the stereoscopic LCD shutter glass (right) 28 is brought into the open state, whereas the stereoscopic LCD shutter glass (left) 27 is brought into the closed state.

The frame data videos displayed on the video display 14 and viewed by the user's right and left eyes are as shown in FIG. 11 by the on/off control of the backlight 26 and the corresponding control for bringing the stereoscopic LCD shutter glass (left) 27 and the stereoscopic LCD shutter glass (right) 28 into the open or closed state, described above. This also applies to the case in which the frame data written to the video display 14 is intended to be viewed by the left eye.

According to the above-described embodiment, even if the frame data intended to be viewed by the user's right eye overlaps the frame data intended to be viewed by the user's left eye in one frame, only the frame data intended to be viewed by each eye is viewed by that eye. Consequently, regardless of the operation speed of the frame data displayed on the video display 14, afterimages in the stereoscopic viewing can be reduced. Furthermore, the present embodiment allows the backlight 26, the stereoscopic LCD shutter glass (left) 27, and the stereoscopic LCD shutter glass (right) 28 to be easily controlled.

Now, the on/off control of the backlight 26 in the digital television broadcasting receiving apparatus 11 according to a third embodiment will be described with reference to FIGS. 13 and 14.

Like FIG. 9, FIG. 13 shows the on/off control of the backlight 26 according to the third embodiment and images viewed by the user. Now, the on/off control of the backlight 26 will be described with reference to a flowchart shown in FIG. 14.

First, the video processing module 55 sets (a)=1 to control the video display 14 and the backlight 26 (step S300). The video processing module 55 turns on a part of the backlight 26 which corresponds to the (a)th line (first, the first line) from the top of the screen, while turning off parts of the backlight 26 which correspond to the other lines (step S301).

Then, the video processing module 55 writes frame data to the (a)th line on the screen of the video display 14 (step S302). Then, the video processing module 55 sets (a)=a+1 to control the video display 14 and the backlight 26 (step S303). The video processing module 55 determines whether or not (a) is equal to the number of the final line on the screen of the video display 14 (step S304). If (a) is not equal to the number of the final line on the screen of the video display 14 (step S304, NO), the video processing module 55 returns to step S101. If (a) is equal to the number of the final line on the screen of the video display 14 (step S304, YES), the video processing module 55 determines whether or not any frame data is present which is to be displayed on the screen of the video display 14 (step S305). If the current frame data is the final (step S305, YES), the video processing module 55 terminates the control of the video display 14 and the backlight 26 (step S306). If the current frame data is not the final (step S305, NO), the video processing module 55 returns to step S300 to control the video display 14 and the backlight 26.

That is, the video processing module 55 performs control such that new frame data is written to the screen of the video display 14 line by line from top to bottom of the screen so as to turn on a part of the backlight 26 which corresponds to lines to which frame data has been written.

The control module 56 performs control such that if the frame data written to the video display 14 is intended to be viewed by the left eye, the stereoscopic LCD shutter glass (left) 27 is brought into the open state (this corresponds to the thick diagonal lines in the figure), whereas the stereoscopic LCD shutter glass (right) 28 is brought into the closed state (this corresponds to the white part in the figure). In contrast, the control module 56 performs control such that if the frame data written to the video display is intended to be viewed by the right eye, the stereoscopic LCD shutter glass (right) 28 is brought into the open state, whereas the stereoscopic LCD shutter glass (left) 27 is brought into the closed state.

The frame data videos displayed on the video display 14 and viewed by the user's right and left eyes are as shown in FIG. 13 by the on/off control of the backlight 26 and the corresponding control for bringing the stereoscopic LCD shutter glass (left) 27 and the stereoscopic LCD shutter glass (right) 28 into the open or closed state, described above. This also applies to the case in which the frame data written to the video display 14 is intended to be viewed by the left eye.

According to the above-described embodiment, even if the frame data intended to be viewed by the user's right eye overlaps the frame data intended to be viewed by the user's left eye in one frame, only the frame data intended to be viewed by each eye is viewed by that eye. Consequently, regardless of the operation speed of the frame data displayed on the video display 14, afterimages in the stereoscopic viewing can be reduced. Furthermore, the present embodiment allows the backlight 26, the stereoscopic LCD shutter glass (left) 27, and the stereoscopic LCD shutter glass (right) 28 to be easily controlled.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lighting panel comprising:
a display configured to switch a first video to a second video for display; and
a lighting module configured to, if while switching from the first video to the second video, the display displays a mixture of an area in which the first video is displayed and an area in which the second video is displayed, turn on lighting for at least a part of one of the area of the display in which the first video is displayed and the area of the display in which the second video is displayed.

2. The lighting panel of claim 1, wherein the display includes n scan lines, and changes the first video to the second video scan line by scan line from the scan line in an uppermost stage toward the scan line in a lowermost stage, and
if the display changes the first video to the second video for an (a)th scan line from the uppermost stage, the lighting module turns off lighting for from the scan line in the uppermost stage down to the (a)th line.

3. The lighting panel of claim 2, wherein if the display changes the first video to the second video for an nth scan line from the uppermost stage, the lighting module turns on lighting for the nth scan line from the uppermost stage.

4. The lighting panel of claim 1, wherein the display includes n scan lines, and changes the first video to the second video scan line by scan line from the scan line in the uppermost stage toward the scan line in the lowermost stage, and
the lighting module turns on lighting for scan lines for one of the first and second videos displayed on the display which has been written to at least half of the n scan lines.

5. The lighting panel of claim 1, wherein the display includes n scan lines, and changes the first video to the second video scan line by scan line from the scan line in the uppermost stage toward the scan line in the lowermost stage, and
the lighting module sequentially turns on lighting for only one scan line for which the display changes the first video to the second video, while turning off lighting for remaining scan lines.

6. A video display apparatus comprising:
a display configured to switch a first video to a second video for display;
a lighting module configured to light the display; and
a control module configured to, if while switching from the first video to the second video, the display displays a mixture of an area in which the first video is displayed and an area in which the second video is displayed, turn on lighting for at least a part of one of the area of the display in which the first video is displayed and the area of the display in which the second video is displayed.

7. The apparatus of claim 6, wherein the display includes n scan lines, and changes the first video to the second video scan line by scan line from the scan line in an uppermost stage toward the scan line in a lowermost stage, and
if the display changes the first video to the second video for an (a)th scan line from the uppermost stage, the control module turns off lighting by the lighting module for from the scan line in the uppermost stage down to the (a)th line.

8. The apparatus of claim 7, wherein if the display changes the first video to the second video for an nth scan line from the uppermost stage, the control module turns on lighting by the lighting module for the nth scan line from the uppermost stage.

9. The apparatus of claim 6, wherein the display includes n scan lines, and changes the first video to the second video scan line by scan line from the scan line in the uppermost stage toward the scan line in the lowermost stage, and
the control module turns on lighting by the lighting module for scan lines for one of the first and second videos displayed on the display which has been written to at least half of the n scan lines.

10. The apparatus of claim 6, wherein the display includes n scan lines, and changes the first video to the second video scan line by scan line from the scan line in the uppermost stage toward the scan line in the lowermost stage, and
the control module sequentially turns on lighting by the lighting module for only one scan line for which the display changes the first video to the second video, while turning off the lighting for remaining scan lines.

11. A video display method comprising:
switching a screen from a first video to a second video for display; and
if during the switching from the first video to the second video, the screen displays a mixture of an area in which the first video is displayed and an area in which the second video is displayed, turning on lighting for at least a part of one of the area of the display in which the first video is displayed and the area of the display in which the second video is displayed.

12. The method of claim 11, comprising:
on the screen with n scan lines on which the first video is being displayed, changing the first video to the second video scan line by scan line from the scan line in an uppermost stage toward the scan line in a lowermost stage, and
to change the first video to the second video for an (a)th scan line from the uppermost stage of the screen, turning off lighting for from the scan line in the uppermost stage down to the (a)th line.

13. The method of claim 12, comprising:
to change the first video to the second video for an nth scan line from the uppermost stage of the screen, turning on lighting for the nth scan line from the uppermost stage.

14. The method of claim 12, comprising:
changing the first video to the second video scan line by scan line from the scan line in the uppermost stage toward the scan line in the lowermost stage, and
turning on lighting for scan lines for one of the first and second videos displayed on the screen which has been written to at least half of the scan lines.

15. The method of claim 11, comprising:
changing the first video to the second video scan line by scan line from the scan line in the uppermost stage toward the scan line in the lowermost stage, and
sequentially turning on lighting for only one scan line for which the first video is changed to the second video, while turning off lighting for remaining scan lines.
